(19) United States
(12) Patent Application Publication
(10) Pub. No.: US 2007/0267458 A1
(43) Pub. Date: Nov. 22, 2007

(54) PNEUMATIC NAIL GUN

(76) Inventor: Mu-Yu Chen, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/419,568

(22) Filed: May 22, 2006

(51) Int. Cl. B25C 1/04

(52) U.S. Cl. 227/130

(57) ABSTRACT

A pneumatic nail gun includes a body, a firing pin, a trigger, a magazine, a connector and a firing chamber. The body includes a cylinder and a handle extended from the cylinder. The firing pin is positioned in the cylinder. The trigger is operable on the body for actuating the firing pin. The magazine is connected to the body and includes an intake portion and first and second valves operable in the intake portion for adjusting a rate at which pressurized air goes into the magazine. The connector includes a first section connected to the cylinder for receiving the firing pin and a second section connected to the magazine for receiving nails. The firing chamber is attached to the second section of the connector for receiving the nails.

### BACKGROUND OF INVENTION

1. Field of Invention

The present invention relates to a pneumatic nail gun and, more particularly, to a low-cost pneumatic nail gun.

2. Related Prior Art

Shown in FIG. 8 is a conventional pneumatic nail gun 90 including a handle 91, a magazine 92 and a cylinder 93. A rear end of the handle 91 is connected to a rear end of the magazine 92. A front end of the handle 91 is connected to an upper end of the cylinder 93. A front end of the magazine 92 is connected to a firing chamber 935 formed at a lower end of the cylinder 93. A firing pin 933 is secured to a piston 932 positioned in a space 931 defined in the cylinder 93. A cover 934 is connected to the upper end of the cylinder 93, thus retaining the piston 932 and the firing pin 933 in the space 931. A holding device 94 is positioned in the firing chamber 935. The holding device 94 includes a first ring 940 attached to the firing chamber 935 by threading, three claws 941 and a second ring 942 attached to the first ring 940 by threading for restraining the claws 941.

The handle 91 is made of plastics so that it is light. The cylinder 93, the piston 932 and the firing pin 933 are made of metal so that they are strong. The upper end of the cylinder 93 is fit in an annular portion formed at the front end of the handle 91. To this end, the size of the cylinder 93 and the size of the annular portion of the handle 91 must be perfectly matched, and this is however difficult and therefore expensive.

The firing chamber 935 is part of the cylinder 93 so that the overall profile of the cylinder 93 is complicated. Therefore, the cylinder 93 has to be machined in various machines before it is finished. This machining requires a lot of labor and results in a high cost.

After some time of use under heavy load, the cylinder 93 could easily be damaged. When this happens, the entire pneumatic nail gun 90 will have to be disposed of since the cylinder 93 is fit in the annular portion of the handle 91 and they cannot be detached from each other.

The present invention is therefore intended to obviate or at least alleviate the problems encountered in prior art.

### SUMMARY OF INVENTION

According to the present invention, a pneumatic nail gun includes a body, a firing pin, a trigger, a magazine, a connector and a firing chamber. The body includes a cylinder and a handle extended from the cylinder. The firing pin is positioned in the cylinder. The trigger is operable on the body for actuating the firing pin. The magazine is connected to the body. The connector includes a first section connected to the cylinder for receiving the firing pin and a second section connected to the magazine for receiving nails. The firing chamber is attached to the second section of the connector for receiving the nails.

An advantage of the pneumatic nail gun of the present invention is that it is manufactured at a high yield since the cylinder and the handle are formed together, and the lining is positioned in the cylinder by the cover without requiring extreme precision in size.

Another advantage of the pneumatic nail gun of the present invention is that it is manufactured at a high speed since the connector and the firing chamber are separately made and easily bonded to the body.

Another advantage of the pneumatic nail gun of the present invention is that it is used at a low running cost since only the firing chamber or the connector has to be replaced with a new one when it is broken without having to replace the entire nail gun with a new one.

Other advantages and features of the present invention will become apparent from the following description referring to the drawings.

### BRIEF DESCRIPTION OF DRAWINGS

The present invention will be described through detailed illustration of the preferred embodiment referring to the drawings.

FIG. 1 is a perspective view of a pneumatic nail gun according to the preferred embodiment of the present invention.

FIG. 2 is an exploded view of the pneumatic nail gun shown in FIG. 1.

FIG. 3 is a cross-sectional view of the pneumatic nail gun taken along a line 3-3 in FIG. 1.

FIG. 4 is a cross-sectional view of the pneumatic nail gun taken along a line 4-4 in FIG. 3.

FIG. 5 is a cross-sectional view of the pneumatic nail gun taken along a line 5-5 in FIG. 4.

FIG. 6 is a cross-sectional view of the pneumatic nail gun in another position than shown in FIG. 5.

FIG. 7 is a cross-sectional view of the pneumatic nail gun taken along a line 7-7 in FIG. 6.

FIG. 8 is an exploded view of a conventional pneumatic nail gun.

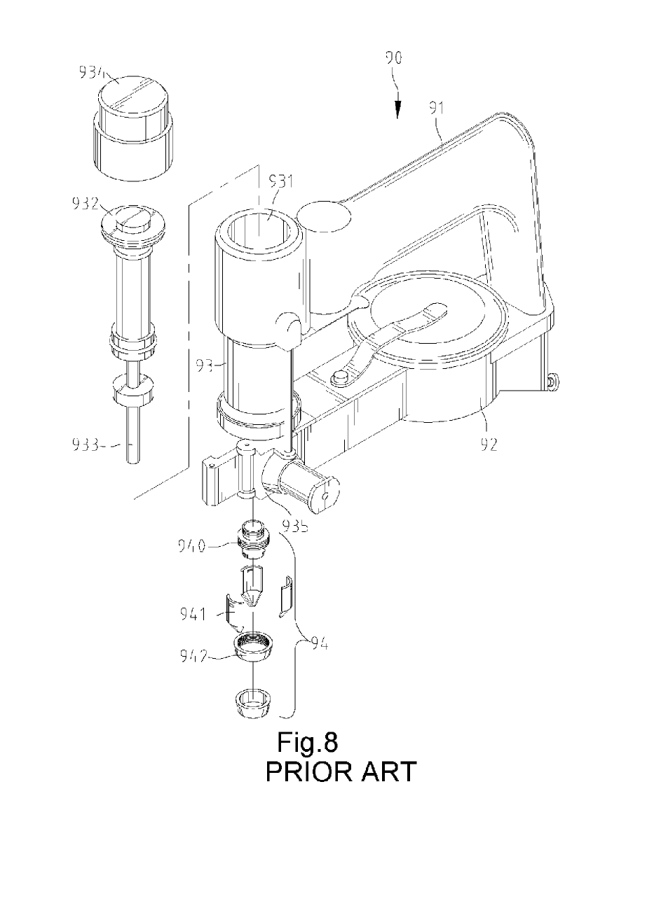

### DETAILED DESCRIPTION OF PREFERRED EMBODIMENT

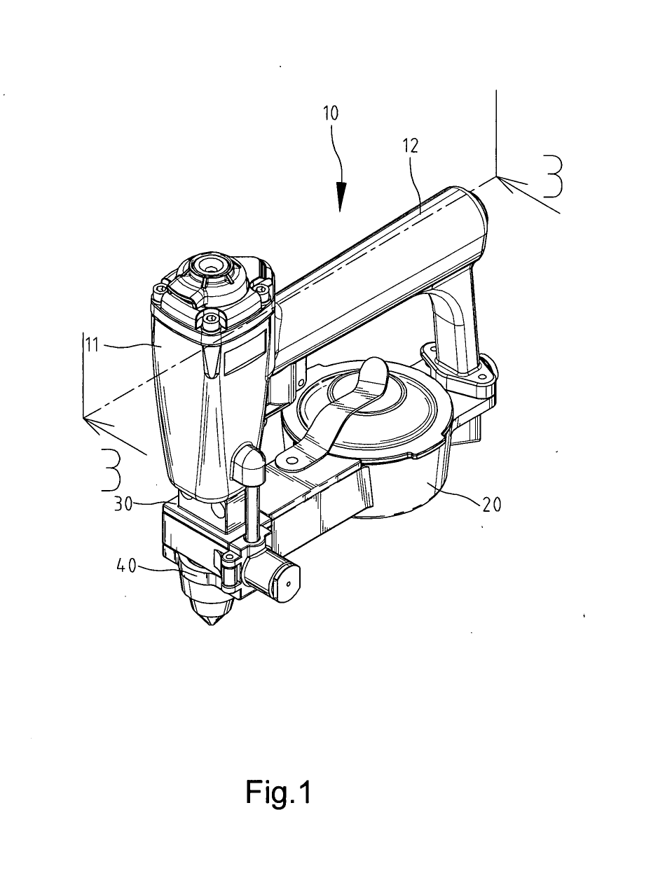

Referring to FIG. 1, there is shown a pneumatic nail gun according to the preferred embodiment of the present invention. The pneumatic nail gun includes a body 10, a magazine 20, a connector 30 and a firing chamber 40.

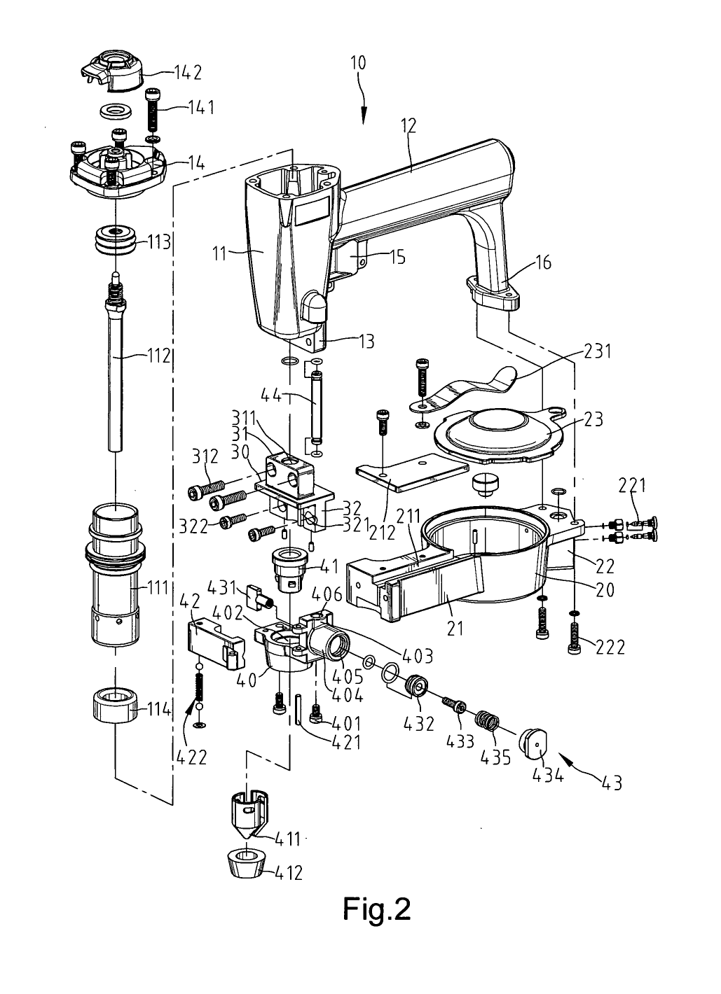

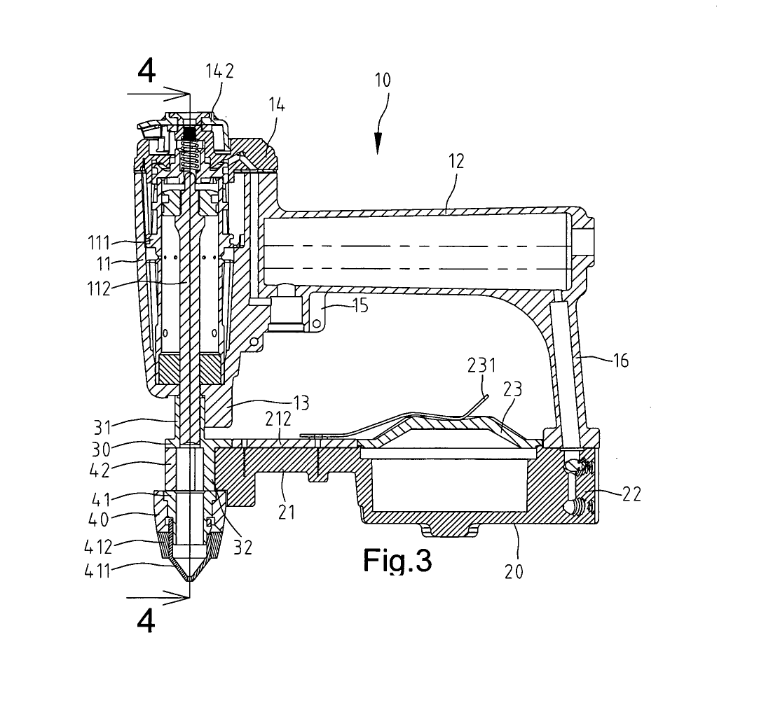

Referring to FIGS. 2 through 4, the body 10 is made of plastics and includes a cylinder 11, a handle 1 2 transversely extended from the cylinder 11, a connective portion 13 longitudinally extended from a lower end of the cylinder 11 and a leg 16 transversely extended from a rear end of the handle 12. A trigger 15 is arranged between the cylinder 11 and the handle 12.

A ring 114 is positioned in the cylinder 11. Also positioned in the cylinder 11 is a lining 111 made of metal. The lining 111 is supported on the ring 114. A firing pin 112 is connected to a piston 113 positioned in the lining 111. By fasteners 141, a cover 14 is installed on the cylinder 11 for keeping the lining 111, the firing pin 112 and the piston 113 in the cylinder 11. Installed on the cover 14 is a screen 142 for venting exhaust.

The magazine 20 is formed with an outlet portion 21 and an intake portion 22 opposite to the outlet portion 21. Two valves 221 are positioned in the intake portion 22. The valves 221 are operable for adjusting a rate at which pressurized air is sent into the magazine 20. The intake portion 22 is secured to a lower end of the leg 16 by fasteners 222. An elastic element 231 includes an end secured to the outlet portion 21 by a fastener and an opposite end for keeping a cover 23 on the magazine 20. The outlet portion 21 defines a T-shaped groove 211 through which nails are transmitted. Attached to the outlet portion 21 is a transparent cover 212 for covering the T-shaped groove 211 so that the nails in the T-shaped groove 211 can be observed from the exterior through the transparent cover 212.

The connector 30 is arranged between the connective portion 13 of the body 10 and the outlet portion 21 of the magazine 20. The connector 30 includes a first section 31 and a second section 32. The first section 31 longitudinally defines a passageway 311 through which the firing pin 112 is inserted. The second section 32 transversely defines a T-shaped opening 321 through which the nails are transmitted. By fasteners 312, the first section 31 of the connector 30 is secured to the connective portion 13 of the body 10. By fasteners 322, the second section 32 of the connector 30 is secured to the outlet portion 21 of the magazine 20. Thus, the body 10, the magazine 20 and the connector 30 are firmly connected to one another.

The firing chamber 40 is secured to the second section 32 of the connector 30 by fasteners 401. The firing chamber 40 includes a space 402 defined therein, a wall 403 formed thereon and a tube 404 transversely extended from the wall 403. A passageway 406 defined in the wall 403 is in communication with a passageway 405 defined in the tube 404.

A holding device includes a first ring 41 located in the firing chamber 40, a second ring 412 located outside the firing chamber 40 and claws 411 each with an first section in contact with the first ring 41 and a second section restrained by the second ring 412. The second ring 412 is an elastic ring for biasing the claws 411.

A door 42 is pivotally connected to the wall 403 by a pin 421. Installed on the door 42 is a locking device 422 for locking the door 42 to the second section 32 of the connector 30. The locking device 422 includes two balls and a spring compressed between the balls. Thus, the holding device can be put into and taken from the firing chamber 40.

A control device 43 is positioned in the passageway 405. The control device 43 includes a pusher 431 located in the space 402, a valve 432 located in the passageway 405, a fastener 433 for connecting the valve 432 to the pusher 431, a spring 435 for biasing the valve 432 and the pusher 431 and a cover 434 attached to the tube 404 for retaining the spring 435 and the valve 432 within the passageway 405. The pusher 431 is located near the T-shaped opening 321.

The passageway 406 is in communication with the cylinder 11 through a pipe 44. The pressurized air is transmitted into the passageway 405 for pushing the valve 432. The valve 432 drives the pusher 431 through the fastener 433. The pusher 431 pushes the nails.

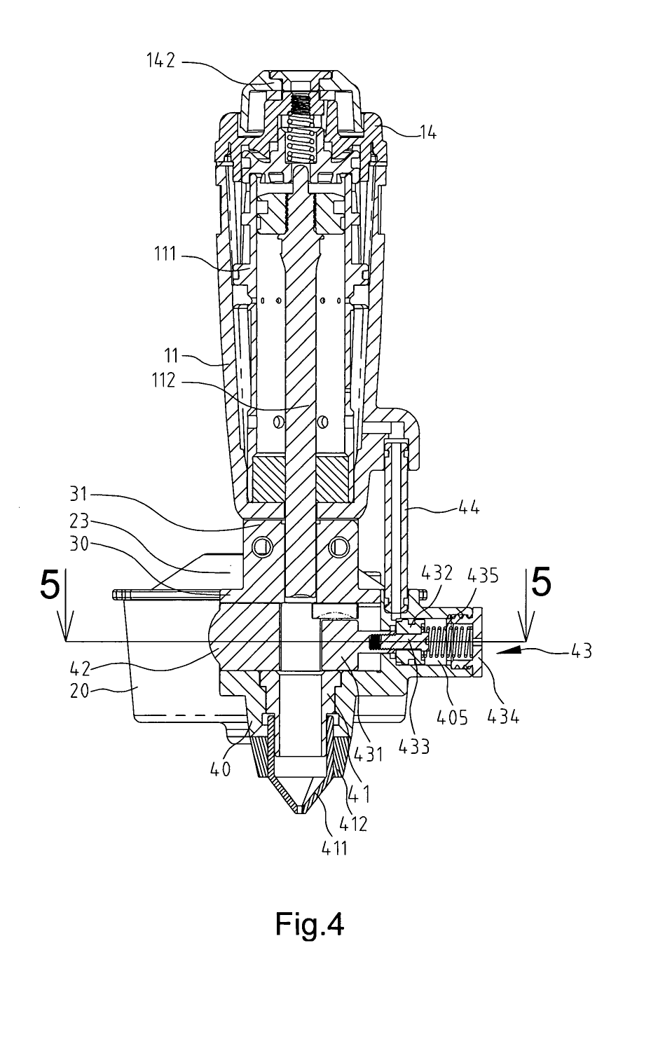

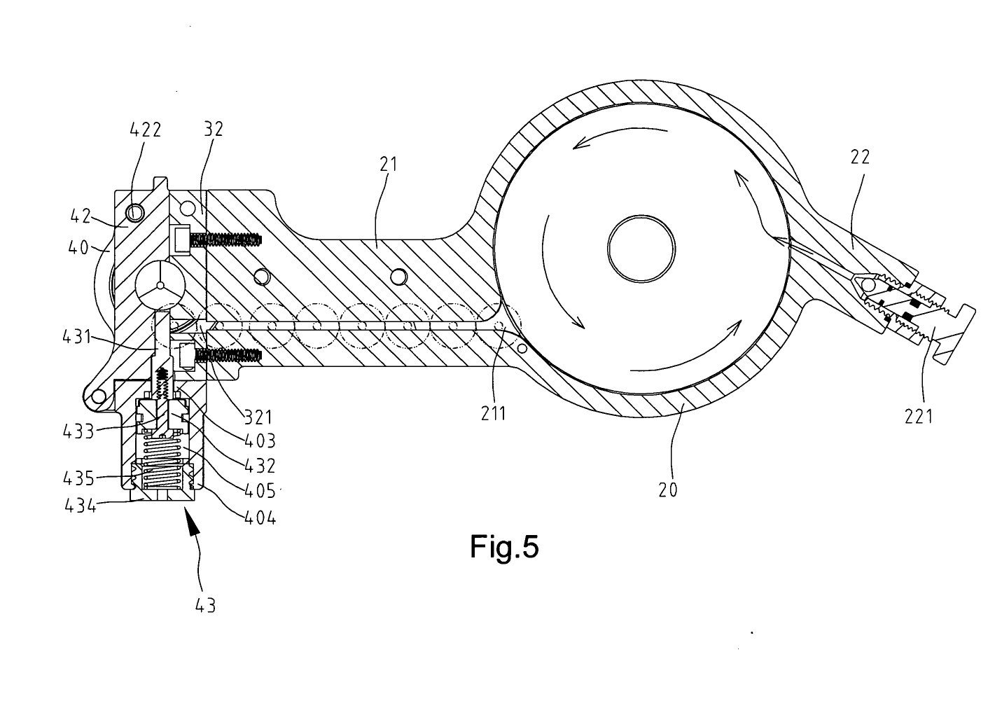

Referring to FIGS. 4 and 5, the pressurized air goes into the magazine 20 and drives the nails counterclockwise for example. The nails move along the internal side of the magazine 20 and advance into the T-groove 211 of the outlet portion 21 of the magazine 20. The trigger 15 is not operated so that the pusher 431 shuts the T-shaped opening 321 and stops the nails.

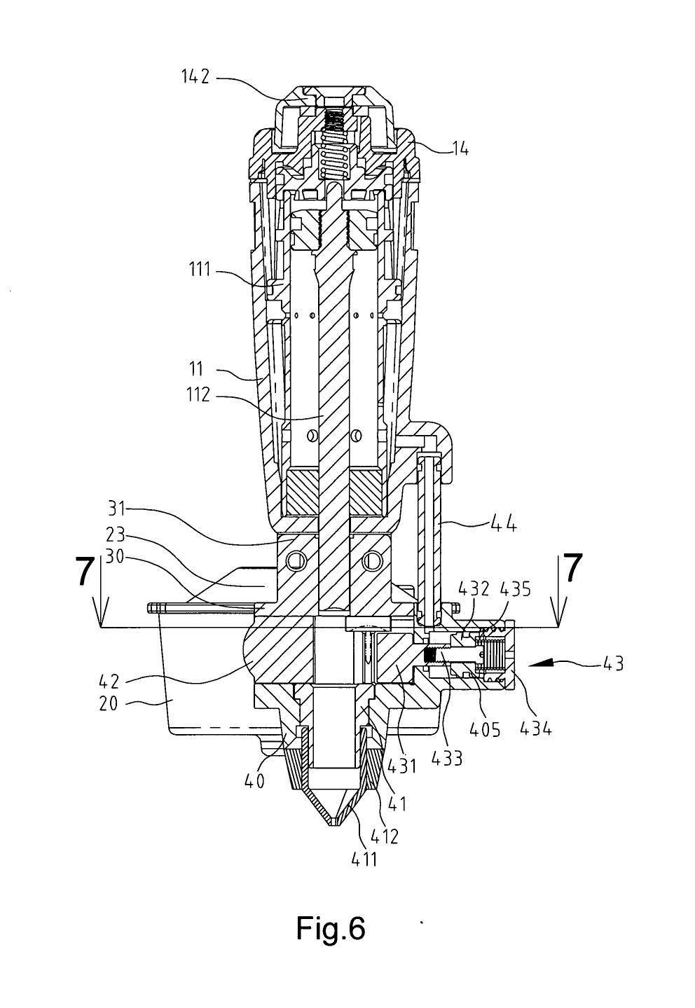

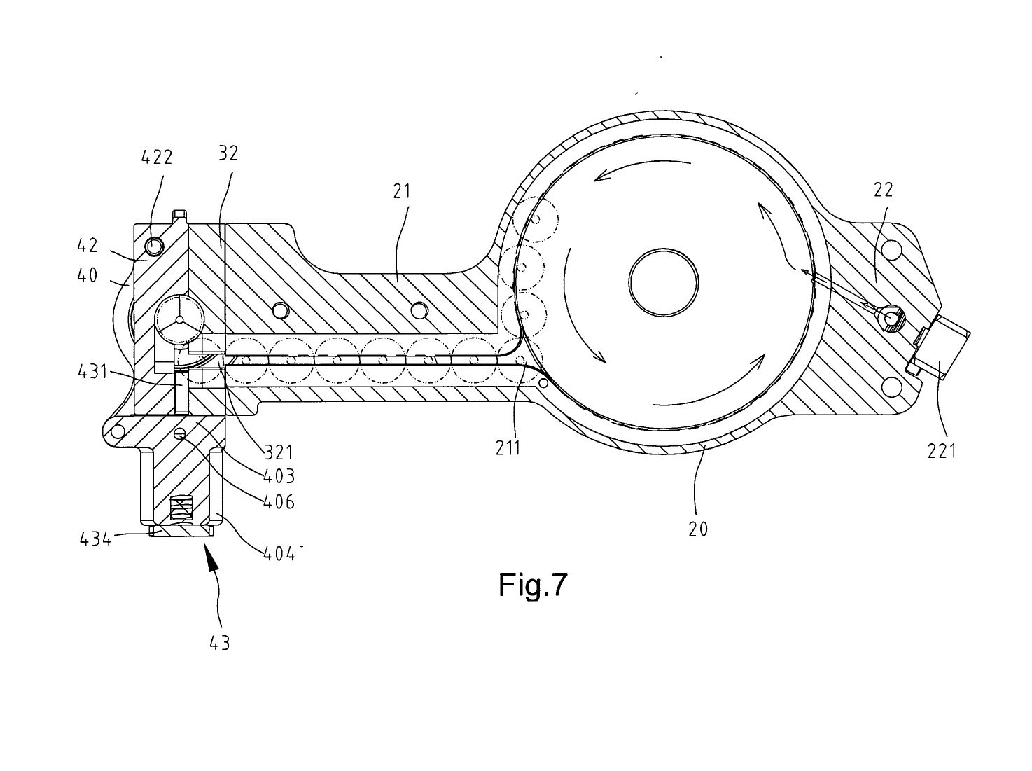

Referring to FIGS. 6 and 7, the trigger 15 is operated. The pressurized air goes into the passageway 405 from the cylinder 11 through the pipe 44 and drives the valve 432 and therefore the pusher 431, against the spring 435. The pusher 431 opens the T-shaped opening 321 of the second section 32 of the connector 30. A leading one of the nails goes into the firing chamber 40 and held by the holding device. Finally, the firing pin 112 hits the leading nail from the holding device.

The pneumatic nail gun of the present invention exhibits several advantages. Firstly, it is manufactured at a high yield since the cylinder and the handle are formed together, and the lining is positioned in the cylinder by the cover without the need of extreme precision in size.

Secondly, it is manufactured at a high speed since the connector and the firing chamber are separately made and easily bonded to the body.

Thirdly, it is used at a low running cost since only the firing chamber or the connector has to be replaced with a new one when it is broken without having to replace the entire nail gun with a new one.

The present invention has been described through the description of the preferred embodiment. Those skilled in the art can derive variations from the preferred embodiment without departing from the scope of the present invention. Therefore, the preferred embodiment shall not limit the scope of the present invention defined in the claims.

1. (canceled)

2. A pneumatic nail gun according to claim 13 wherein the cylinder comprises a connective portion formed at a lower end for the connector.

3. A pneumatic nail gun according to claim 13 wherein the magazine comprises an outlet portion formed thereon and connected to the second section of the connector.

4. A pneumatic nail gun according to claim 13 comprising a cover for covering the cylinder.

5. A pneumatic nail gun according to claim 4 comprising a screen installed on the cover for venting exhaust.

6. A pneumatic nail gun according to claim 13 comprising a lining positioned between the cylinder and the firing pin.

7. A pneumatic nail gun according to claim 6 comprising a piston connected to the firing pin within the lining.

8. A pneumatic nail gun according to claim 6 comprising a ring for supporting the lining within the cylinder.

9. A pneumatic nail gun according to claim 3 wherein the outlet portion of the magazine defines a groove for guiding the nails.

10. A pneumatic nail gun according to claim 9 comprising a transparent cover for covering the groove so that the nails can be observed from the exterior through the transparent cover.

11. A pneumatic nail gun according to claim 9 wherein the connector comprises an opening in the second section for receiving the nails from the groove of the outlet portion of the magazine.

12. A pneumatic nail gun according to claim 13 wherein the body comprises a leg extended from the handle and connected to the magazine.

13. A pneumatic nail gun comprising:
a body comprising a cylinder and a handle extended from the cylinder;
a firing pin positioned in the cylinder;
a trigger operable on the body for actuating the firing pin;
a magazine connected to the body, with the magazine including an intake portion and first and second valves operable in the intake portion for adjusting a rate at which pressurized air goes into the magazine, with the first valve controlling the inlet of the pressurized air into the magazine through the intake portion and the second valve controlling the release of the pressurized air from the magazine through the intake portion;
a connector comprising a first section connected to the cylinder for receiving the firing pin and a second section connected to the magazine for receiving nails; and
a firing chamber attached to the second section of the connector for receiving the nails.

14. A pneumatic nail gun according to claim 13 comprising a cover for covering the magazine.

15. A pneumatic nail gun according to claim 14 comprising an elastic element connected to the magazine for restraining the cover.

16. A pneumatic nail gun according to claim 13 wherein the firing chamber comprises a wall formed thereon and connected to the second section of the connector.

17. A pneumatic nail gun according to claim 16 wherein the firing chamber comprises a door connected to the wall.

18. A pneumatic nail gun according to claim 17 wherein the firing chamber comprises a locking device for locking the door to the second section of the connector.

19. A pneumatic nail gun according to claim 13 comprising a holding device for holding a leading one of the nails which goes to the firing chamber.

20. A pneumatic nail gun comprising:
a body comprising a cylinder and a handle extended from the cylinder;
a firing pin positioned in the cylinder, with the firing pin movable in a firing direction;
a trigger operable on the body for actuating the firing pin;
a magazine defining a plane of movement for nails, with the magazine connected to the body and including an intake portion for introducing pressurized air into the magazine and pushing nails in the plane of movement, with the firing direction being parallel to and spaced from the plane of movement; and
a pusher movable in a pushing direction, with the pushing direction generally perpendicular to the firing direction and at a nonparallel angle to the plane of movement, with the pusher pushing a leading one of the nails from the plane of movement into alignment with the firing pin for movement in the firing direction.

21. A pneumatic nail gun according to claim 20 further comprising a connector including a first section connected to the cylinder and for receiving the firing pin and a second section connected to the magazine for receiving nails.
